(19) United States
(12) Patent Application Publication
(10) Pub. No.: US 2007/0100051 A1
(43) Pub. Date: May 3, 2007

(54) Shredder dust for recycling, molding for shredder dust and a method for recovering lactide from the shredder dust as well as molding formed from the lactide

(75) Inventor: Jun Takagi, Nagahama-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: MITSUBISHI PLASTICS, INC., Tokyo (JP)

(21) Appl. No.: 11/641,749

(22) Filed: Dec. 20, 2006

Related U.S. Application Data
(62) Division of application No. 10/838,223, filed on May 5, 2004.

(51) Int. Cl. C08K 3/34

(52) U.S. Cl. 524/442

(57) ABSTRACT

To provide moldings such as automobile parts and home electric appliance parts having excellent physical properties and recyclability, and shredder dust for recycling to produce a resource as well as a method for recycling the shredder dust, the shredder dust for recycling to produce a resource includes a pulverisate of a molding consisting mainly of a lactic acid-based resin composition. The lactic acid-based resin composition includes: 1) 30 to 100% by weight of a lactic acid-based resin; 2) 0 to 50% by weight of an aliphatic polyester and/or an aromatic-aliphatic polyester having a glass transition temperature, Tg, of 0° C. or less; 3) 0 to 50% by weight of an inorganic filler; 4) 0 to 10% by weight of a hydrolysis inhibitor; and 5) 0 to 50% by weight of a plasticizer.

### BACKGROUND OF THE INVENTION

1. Field of the Invention

The present invention relates to automobile parts and home electric appliance parts which have excellent recyclabilities, to shredder dust of these parts, and to a method for recovering lactide from the shredder dust, as well as to moldings formed from the lactide.

2. Description of the Related Art

Recently, in Japan, “used automobiles” occur at a rate of about 5,000,000 a year. Among them, 4,000,000 to 4,500,000 automobiles remaining after excluding those automobiles which are exported as secondhand automobiles become targets of scrapping and recycling. The target automobiles are presumed to include so-called illegally abandoned automobiles in amounts of 1% by weight or less based on the total weight of the used automobiles. The illegally abandoned automobiles are recovered and disposed by, for example, cooperative associations for disposal of abandoned vehicle on a road. Thus, finally, 99% by weight or more of the automobiles that became the target of scrapping and recycling is recovered and disposed. Recycling of the target automobiles is performed as described below.

The recovered “used automobiles” are scrapped by personnel of scrapping industry, or scrappers. A portion of the obtained parts is supplied to the market as secondhand parts while the remainder becomes body scrap after proper treatments, for example, removing liquids such as gasoline and oil and dangerous articles such as batteries.

The body scrap is in wide circulation as it is, i.e., in the form that still contains the glass and/or sheet as a metallic raw material. Then, the body scrap is recycled by the shredder industry that performs subsequent steps. In the shredder industry, the body scrap is shredded by using a shredding machine or shredder and “sorted” by using a mechanical sorter or manually to recover metals and at the same time fragments of glass and waste plastics are separated as shredder dust. Thereafter, the separated shredder dust is used to be usually disposed of by using it in earth filling or reclaiming. Such a recycling system has become popular since 1970 and at present 75 to 80% by weight of automobiles based on the total weight of the automobiles is recycled in this manner.

However, most recently, in the shredder industry, the economical efficiency of recycling has been drastically reduced due to drop of the price and continuous increase in the cost of garbage landfilling, with the result that the body scrap is becoming to be handled as “industrial waste” rather than “valuable resource”.

Lawsuits against garbage landfill sites everywhere are brought by dwellers in the area and now it is very difficult to secure a new garbage landfill site. Under the circumstances, the cost for garbage landfilling of shredder dust will be ever increasing but is not in a position to decrease at all.

Thus far, the shredder dust, which is considered to be a waste basically containing no injurious substances, such as fragments of glass and waste plastics, has been subjected to landfilling in a stabilized type garbage landfill site that is not provided with water disposal function. Incidentally, cases of illegal abandonment of industrial wastes including shredder dust have occurred and most of their solution has not yet in sight.

Thereafter, fact-finding by the Ministry of Health and Welfare and the Ministry of Economy, Trade and Industry has started, resulting reinforcement of the environmental criteria relating to water pollution in 1993 and revision of the Waste Disposal Act in 1994; it was decided that the treatment of shredder dust is shifted from the conventional “treatment in a stabilized type garbage landfill site” to “treatment in a controlled type landfill site” with a water insulation function and a liquid waste treatment function. This caused further escalating of cost of landfilling since the cost of treatment in a controlled type garbage landfill site is higher than that of treatment in a stabilized type garbage landfill site.

The movements of the government and industrial world around recycling of used automobiles are synchronized with the worldwide movements. In Japan, “Recycle Initiative” has been finalized and published in 1997 by the Ministry of Economy, Trade and Industry for promoting the recycling of automobiles not by legal control but by autonomous efforts by the industrial world.

The target value of recycling rate in the country was 85% by weight or more in 2002, and will be 95% by weight or more in 2015. Further, Japan's own target was to make the amount of shredder dust to be treated by landfilling to three fifths or less in 2002 and to one fifth or less in 2015.

At present, 75 to 80% by weight of automobiles are recycled to serve as a resource again through the stages of scrapping, shredding, and separating shredder dust and the balance, i.e., 20 to 25% by weight of the automobiles is disposed of as shredder dust by garbage landfilling.

Under the circumstances, the problems relating to waste disposal of automobiles is how to create a new recycle route in place of garbage landfilling of shredder dust. For this purpose, it becomes necessary to develop new recycling technologies including a thermal recycling technology. Development of the thermal recycling technology has progressed in its own way. However, satisfactory recycling technologies have not been obtained yet, partly because of occurrence of dioxine accompanying combustion and partly because of disposal of combustion residues. In addition, conversion of the shredder dust into oil is being studied. However, it is not yet practically acceptable because of the problems of purity of the obtained oil and so forth.

On the other hand, in recycling of home electric appliances, Home Electric Appliances Recycling Act has come into force in 2001, which gradually increases the recycle rate of parts and so forth. Casing and the like remaining after removal of useful parts such as substrates and motors, in particular casing of large-sized home electric appliances, often together with automobile body scraps, are finally converted into shredder dust. Thus, recycling of home electric appliances faces the same problems as those in the recycling of automobiles.

Accordingly, it has been desired to recycle shredder dust to give a resource without subjecting it to garbage landfilling. In addition, it has been keenly desired to make shredder dust to serve as a resource again by a simple process.

For example, Published Japanese Patent Application No. 2002-224652 discloses a method for obtaining styrene monomers from shredder dust. This method can give styrene monomers only after a plurality of processes such as separation by magnetism, separation by eddy current, separation by specific density in water, separation by specific density in air and so forth. Apparently, this method does not perform chemical recycling of shredder dust in one process or a small number of steps close to one.

Further, Published Japanese Patent Application No. Hei 9-77904 discloses a method for recovering lactide in which a high molecular weight polylactic acid is reacted after addition of a catalyst. This method uses trimmings that remain after the molding is cut to a fixed length as a starting material. The starting material contains no material other than polylactic acid and is quite different from the shredder dust that inevitably contains contamination such as metals and glass.

Incidentally, the shredder dust of automobiles and home electric appliances include 49% by weight of resins, 15% by weight of fibers, and 7% by weight of rubbers and thus, two thirds of the total is occupied by polymers, i.e., resins in a broad sense. In other words, the problem of shredder dust is nothing other than the problem of “treatment of resins that are mixed with metals and/or glass”, in particular the problem of “treatment of resins to which metals are attached”. To solve the problems of automobile wastes and home electric appliances and promote recycling to give a resource again as targeted, it is necessary to develop parts and shredder dust thereof having excellent recyclability as a resource and establish an economical recycling method therefor.

### SUMMARY OF THE INVENTION

Under the circumstances, the present invention has been made. It is an object of the present invention to provide shredder dust having excellent recyclability as a resource. It is another object of the present invention to provide automobile parts, home electric appliances and the like, in particular moldings of automobile parts, home electric appliances and the like for such shredder dust. It is still another object of the present invention to provide a method for recovering lactide from the shredder dust. Also, it is an object of the present invention to provide moldings formed from the lactide.

Under the circumstances, the inventors of the present invention have made extensive study and as a result have completed the present invention.

That is, the moldings of the present invention is featured by consisting mainly of a lactic acid composition that includes: 1) 30 to 100% by weight of a lactic acid-based resin; 2) 0 to 50% by weight of an aliphatic polyester and/or an aromatic-aliphatic polyester having a glass transition temperature, Tg, of 0° C. or less; 3) 0.1 to 50% by weight of an inorganic filler; 4) 0 to 10% by weight of a hydrolysis inhibitor; and 5) 0 to 50% by weight of a plasticizer, and in which at least a portion of the inorganic filler is lamellar silicate.

Here, the molding may be an automobile part or a home electric appliance part.

The molding may be a fiber structure form.

The lactic acid-based resin may be a mixture of a substantial poly-L-lactic acid and a substantial poly-D-lactic acid and forms a stereocomplex.

The shredder dust for recycling to produce a resource according to the present invention is featured by being derived from a molding from a lactic acid-resin composition, wherein the lactic acid-based resin composition comprises: 1) 30 to 100% by weight of a lactic acid-based resin; 2) 0 to 50% by weight of an aliphatic polyester and/or an aromatic-aliphatic polyester having a glass transition temperature, Tg, of 0° C. or less; 3) 0 to 50% by weight of an inorganic filler; 4) 0 to 10% by weight of a hydrolysis inhibitor; and 5) 0 to 50% by weight of a plasticizer.

Here, it is preferable that the inorganic filler is contained in amounts of 0.1 to 50% by weight and at least a portion of the inorganic filler is lamellar silicate, and the lamellar silicate forms nano-composite after molding.

The molding is preferably an automobile part or a home electric appliance part.

The lactic acid-based resin may have a relative degree of crystallization of 30 to 100%.

The hydrolysis inhibitor may be at least one member selected from the group consisting of hydrophobic waxes, hydrophobic plasticizers, olefin resins and carbodiimides.

The recovery method for recovering a vapor according to the present invention is featured by heating shredder dust at 150 to 280° C. to recover a vapor component.

Here, the vapor component is preferably lactide.

The lactic acid-based resin composition contained in the shredder dust for recycling to produce a resource preferably contains 0.1 to 1.0% by weight of moisture at the time of the heating.

It is preferable that the recovery method further includes the steps of: heating the shredder dust to generate a vapor component; and cooling the vapor component at 95° C. or less to render the vapor component a solid state for recovering.

The recovering may be performed in the absence of catalysts.

According to another mode of the present invention, the molding is featured by including a lactic acid-based resin for recycling, the lactic acid-based resin for recycling including a polymer of the above-mentioned vapor component.

Here, it is preferable that the lactic acid-based resin for recycling has a relative degree of crystallization of 30 to 100%.

The lactic acid-based resin for recycling may further contain 0.1 to 10% by weight of the hydrolysis inhibitor and the hydrolysis inhibitor may be is at least one member selected from the group consisting of hydrophobic waxes, hydrophobic plasticizers, olefin resins and carbodiimides.

The lactic acid-based resin for recycling may be a mixture of a substantial poly-L-lactic acid and a substantial poly-D-lactic acid and may form a stereocomplex.

The lactic acid-based resin for recycling may further contain 0.1 to 50% by weight of the inorganic filler, at least a portion of which may be lamellar silicate; and the lamellar silicate may form nano-composite after molding.

The molding may be in the form of one selected from a rigid form, an elastic form, a fiber structure form, or an expanded form.

The molding may be molded by one method selected from the group consisting of an injection molding method, an extrusion molding method, a press molding method, a blow molding method, and a sheet molding compound (SMC) method.

The molding may be a fiber structure form.

The fiber structure form may be a structure complexed with natural fiber.

### BRIEF DESCRIPTION OF THE DRAWINGS

FIG. 1 is a schematic diagram showing a method for recovering lactide from shredder dust according to a first embodiment of the present invention; and

FIG. 2 is a graph showing relationship between storage elastic modulus of a filler-blended preparation of polylactic acid and temperature.

### DETAILED DESCRIPTION

Hereinafter, the present invention will be described in detail.

“Shredder dust for recycling” as used herein refers to shredder dust that is rendered usable again as a resource by a treatment in a larger amount than the amount in which it has to be disposed of as a waste. Here, the shredder dust has a particle size of, preferably about 20 mm or less, more preferably about 10 mm or less.

Examples of the shredder dust for recycling of the present invention include pulverisates of automobile parts, home electric appliance, etc. that consist mainly of lactic acid-based resins. Here, “automobile parts” include besides parts related to automobiles, parts, casing, etc. that constitute an automobile. “Home electric appliances” include, for example, besides ordinary parts such as a shade of a lamp, those parts, casing, etc. of home electric appliance. From the viewpoint of directly answering the public need, however, it is preferable that attention be focused on the shredder dust produced by shredding various moldings in waste automobile parts, waste home electric appliances, etc.

The term “lactic acid based resins” as used herein refers to poly-L-lactic acid whose structural unit is L-lactic acid, poly-D-lactic acid whose structural unit is D-lactic acid, poly-DL-lactic acid whose structural unit includes L-lactic acid and D-lactic acid, and mixtures thereof. The lactic acid based resins may be copolymers with α-hydroxycarboxylic acids, diols/dicarboxylic acids.

It is important, however, that the lactic acid-based resins have a DL composition such that L-form:D-form=100:0 to 90:10, or L-form:D-form=0:100 to 10:90. Outside the range, it becomes difficult for the parts to have satisfactory heat resistance so that sometimes their use might be limited. Note that in the present invention, it is preferable that L-form: D-form=99.5:0.5 to 94:6, or L-form:D-form=0.5:99.5 to 6:94.

Any one of known methods such as a condensation polymerization method and a ring opening polymerization method may be adopted as the polymerization method for lactic acid-based resins. For example, in the condensation polymerization method, L-lactic acid or D-lactic acid or a mixture of these is directly polymerized by condensation with dehydration to obtain a lactic acid-based resin with a desired composition.

In the ring opening polymerization method, lactide, which is a cyclic dimer of lactic acid, is polymerized in the presence of a selected catalyst, optionally using a polymerization regulator to obtain polylactic acid-based polymers. Lactide includes L-lactide, which is a dimer of L-lactic acid, D-lactide, which is a dimer of D-lactic acid, and DL-lactide consisting of L-lactic acid and D-lactic acid. Polymerization of these optionally mixing can give rise to lactic acid-based resins having desired compositions and degree of crystallization.

Further, if desired to increase heat resistance or the like, non-aliphatic dicarboxylic acids such as terephthalic acid and/or non-aliphatic diols such as bisphenol A-ethylene oxide adducts may be used as a comonomer or comonomers in small amounts. Furthermore, for the purpose of increasing the molecular weight, a small amount of chain extender, for example, a diisocyanate compound, an epoxy compound, an acid anhydride or the like may be used.

Other examples of hydroxycarboxylic acid unit to be copolymerized in the lactic acid-based resins include difunctional aliphatic hydroxycarboxylic acids such as optical isomers of lactic acid (D-lactic acid for L-lactic acid, L-lactic acid for D-lactic acid), glycolic acid, 3-hydroxybutyric acid, 4-hydroxybutyric acid, 2-hydroxy-n-butyric acid, 2-hydroxy-3,3-dimethylbutyric acid, 2-hydroxy-3-methylbutyric acid, 2-methyllactic acid, and 2-hydroxycaproic acid; and lactones such as caprolactone, butyrolactone, and valerolactone.

The aliphatic diols to be copolymerized in the lactic acid-based resins include ethylene glycol, 1,4-butanediol, 1,4-cyclohexanedimethanol and so forth. In addition, examples of the aliphatic dicarboxylic acid include succinic acid, adipic acid, suberic acid, cebacic acid, dodecanedioic acid and so forth.

The most preferable copolymer is a block copolymer. Assuming that a polylactic acid segment is named A, and, for example, a diol dicarboxylic acid segment is named B, formation of typically an ABA block copolymer can give rise to a polymer having both transparence and impact strength. In this case, it is preferable that the glass transition temperature (Tg) of the segment B be 0° C. or less in order for the resin to exhibit impact strength.

A preferred range of the weight average molecular weight of the lactic acid-based resin is 50,000 to 400,000, more preferably 100,000 to 250,000. When the weight average molecular weight is below 50,000, the resin shows substantially no useful physical properties while the weight average molecular weight is above 400,000, the resin sometimes has too high a melt viscosity to be suitably molded.

In the present invention, it is desirable that the lactic acid-based resin composition is formulated so as to have a composition containing: 1) 30 to 100% by weight of a lactic acid-based resin, 2) 0 to 50% by weight of an aliphatic polyester and/or an aromatic-aliphatic polyester, having a Tg of 0° C. or less, 3) 0 to 50% by weight of an inorganic filler, 4) 0 to 10% by weight of a hydrolysis inhibitor, and 5) 0 to 50% by weight of a plasticizer, each based on the total amount of the composition, provided that the total amount of 1), 2), 3), 4) and 5) is 100%.

Mixing 50% by weight or less, preferably 3% by weight to 35% by weight of an aliphatic polyester and/or an aromatic-aliphatic polyester having a glass transition temperature of 0° C. or less, preferably −20° C. or less enables imparting automobile parts, home electric appliances, etc. with impact strength. At a glass transition temperature, Tg, of above 0° C., the effect of improving the impact strength of the lactic-acid based polymer becomes poor. On the other hand, when the amount of the aliphatic polyester and/or the aromatic-aliphatic polyester mentioned above exceeds 50% by weight, sometimes a reduction in recycling rate tends to occur.

Examples of the aliphatic polyester and/or aromatic-aliphatic polyester include aliphatic polyester resins excluding lactic acid-based resins, for example, aliphatic polyesters and/or aliphatic aromatic polyesters obtained by condensation of aliphatic diols with aliphatic dicarboxylic acids and/or aromatic dicarboxylic acids, and aliphatic polyesters obtained by ring opening polymerization of cyclic lactones, synthesized aliphatic polyesters and so forth.

The aliphatic polyesters and/or aliphatic aromatic polyesters obtained by condensation of aliphatic diols with aliphatic dicarboxylic acids and/or aromatic dicarboxylic acids can be obtained by condensation polymerization of at least one member selected from ethylene glycol, 1,4-butanediol, 1,4-cyclohexanedimethanol, etc., which are aliphatic diols and at least one member selected from succinic acid, adipic acid, suberic acid, cebacic acid, dodecanedioic acid, etc., which are aliphatic dicarboxylic acids, and/or terephthalic acid, isophthalic acid, naphthalenedicarboxylic acid, etc., which are aromatic dicarboxylic acids. Jump up with isocyanates, epoxy compounds, etc. as necessary can give rise to desired polymers. Specific examples of the aliphatic polyester include Bionore manufactured by Showa High Polymer Co., Ltd., Enpole manufactured by Ire Chemical Co., Ltd., Upeck manufactured by Mitsubishi Gas Chemical Co., Ltd., Easterbio manufactured by Eastman Chemical, Ecoflex manufactured by BASF and so forth.

The aliphatic polyesters obtained by ring opening polymerization of cyclic lactones include those obtained by polymerizing at least one cyclic monomer. Typical examples of the cyclic monomer selected include ε-caprolactone, δ-valerolactone, β-methyl-δ-valerolactone and the like.

Examples of the synthesized aliphatic polyester include copolymers of cyclic acid anhydrides and oxiranes, for example, succinic acid anhydride and ethylene oxide, propylene oxide and the like.

The inorganic filler is added in order to increase the rigidity, abrasion resistance, heat resistance (also nucleating agent effect), durability and so forth of the objective polymers. Specific examples thereof include silica, talc, kaolin, clay, alumina, nonswellable mica, calcium carbonate, calcium sulfate, magnesium carbonate, diatomaceous earth, asbestos, glass fiber, metal powder, etc. The amount of inorganic filler to be added is 50% by weight or less, preferably 0.1% by weight or more and 30% by weight or less, particularly preferably 5% by weight or more and 30% by weight or less. When this amount is above 50% by weight, the resin tends to have decreased impact strength, moldability, resistance to hydrolysis and so forth, which is undesirable.

It is also possible to use lamellar silicates as an inorganic filler or in combination with another inorganic filler. The lamellar silicates form nano-composites with lactic acid-based resins to drastically improve the heat resistance and rigidity of the parts. Aligned flat-shaped particles will make prevent invasion of water into the inside of the parts, so that the parts can have increased resistance to hydrolysis and increased gas barrier properties. When nano-dispersed in resins, however, the lamellar silicates will considerably decrease melt moldability due to an increase in viscosity. Accordingly, the amount of the lamellar silicates to be added is 0.1% by weight or more and 10% by weight or less, preferably up to 5% by weight. The term “nano-composite” as used herein refers to a dispersion of inorganic filler in a size on the order of 1 to 100 nm. Dispersion in such a state improves the heat resistance and mechanical properties of the resin as compared with dispersions having sizes on the order of micron (μm) generally used.

The lamellar silicate is a substance constituted by flat-shaped crystal layers, in which a single flat-shaped crystal layer has a 2:1 type multi-layer structure consisting of an octahedral sheet that includes an element selected from aluminum, magnesium, lithium and the like and a tetrahedral sheet of silicic acid on each side of the octahedral sheet. In the interlayer interstices between the flat-shaped crystal layers, exchangeable cations exist. The size of a single flat-shaped crystal is usually 0.05 μm to 0.5 μm in width and 6 Angstroms to 15 Angstroms in thickness. The exchangeable cations have a cation exchange volume of 0.2 meq/g to 3 meq/g, preferably 0.8 meq/g to 1.5 meq/g.

Specific examples of lamellar silicate include smectite clay minerals such as montmorillonite, beidellite, nontronite, saponite, hectorite, and sauconite, various clay minerals such as vermiculite, halloysite, kanemite, kenyte, zirconium phosphate, and titanium phosphate, swelling micas such as Li-type fluorine taeniolite, Na-type fluorine taeniolite, Na-type tetrasilicon fluorine mica, and Li-type tetrasilicon fluorine mica and so forth. They may be natural or synthetic. Among them, smectite clay minerals such as montmorillonite and hectorite, and swelling synthetic micas such as Na-type tetrasilicon fluorine mica and Li-type fluorine taeniolite are preferable.

The lamellar silicates are preferably those lamellar silicates in which the interlayer exchangeable cations are exchanged with organic onium ions. Unexchanged lamellar silicates may induce hydrolysis of the lactic acid-based resins. Examples of the organic onium include ammonium ion, phosphonium ion, sulfonium ion and so forth. Among them, ammonium ions and phosphonium ions are preferable, with ammonium ions being used particularly preferably. Ammonium ions may be any one of primary ammonium ions, secondary ammonium ions, tertiary ammonium ions, and quaternary ammonium ions. Examples of primary ammonium ion include decylammonium ion, dodecylammoniumion, ocatadecylammoniumion, oleylammoniumion, benzylammonium ion and so forth.

Examples of the secondary ammonium ion include methyldodecylammonium ion, methyloctadecylammonium ion and so forth. Examples of the tertiary ammonium ion include dimethyldodecylammonium ion, dimethyloctadecylammonium ion and so forth. Examples of the quaternary ammonium ion include benzyltrialkyl ammonium ions such as benzyltrimethylammonium ion, benzyltriethyl ammonium ion, benzyltributylammonium ion, benzyldimethyldodecylammonium ion, and benzyldimethyloctadecylammonium ion, alkyltrimethylammonium ions such as trioctylmethylammonium ion, trimethyloctyl ammonium ion, trimethyldodecylammonium ion, and trimethyloctadecylammonium ion, dimethyldialkylammonium ions such as dimethyldioctylammonium ion, dimethyldodecylammonium ion, dimethyldioctadecylammonium ion and so forth.

In addition to these, those ammonium ions which are derived from aniline, p-phenylenediamine, α-naphthylamine, p-aminodimethylaniline, benzidine, pyridine, piperidine, 6-aminocaproic acid, 11-aminoundecanoic acid, 12-aminododecanoic acid and so forth may be exemplified. Among these ammonium ions, trioctylmethylammonium ion, trimethyloctadecylammonium ion, benzyldimethyldodecylammonium ion, benzyldimethyloctadecylammonium ion, octadecylammonium ion, ammonium ion derived from 12-aminododecanoic acid and so forth are preferably used.

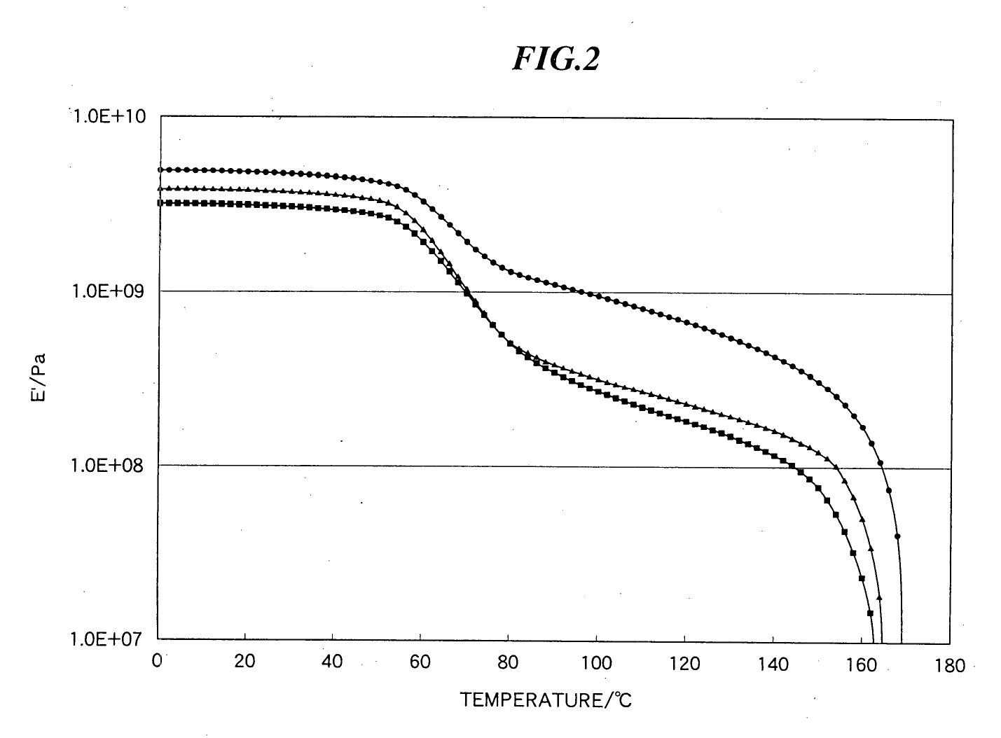

FIG. 2 is a diagram showing temperature dependence of the storage elastic modulus of a blend preparation consisting of polylactic acid in which an inorganic filler is blended. Here, the symbol “●” indicates a blend preparation which contains 5 parts by weight of organic-modified bentonite consisting of montmorillonite modified with quaternary ammonium cation on the surface of the crystal (manufactured by Hojun Co., Ltd.) per 100 parts by weight of polylactic acid. The symbol “▴” indicates a blend preparation which contains 10 parts by weight of talc per 100 parts by weight of polylactic acid. The symbol “▪” indicates a preparation which consists of only polylactic acid. FIG. 2 shows that the blend preparation which contains organic-modified bentonite forms nano-composite so that it has an increased storage elastic modulus. Therefore, the blend preparation which contains organic-modified bentonite does not undergo deformation at a temperature, e.g., 130° C., at which the preparation which consists of only polylactic acid or the blend preparation which contains talc will be deformed.

The hydrolysis inhibitors are added in order to impart the resins with durability required for automobile parts, home electric appliance parts and so forth. The hydrolysis inhibitors include various types such as hydrophobic waxes, hydrophobic plasticizers, olefin resins, and carbodiimide compounds.

Examples of the hydrophobic wax include 1) hydrocarbon waxes such as liquid paraffin, natural paraffin, synthetic paraffin, microcrystalline wax, polyethylene wax, and fluorocarbon wax; 2) fatty acid waxes such as higher fatty acids and oxyfatty acids; 3) aliphatic amide waxes such as aliphatic amides and alkylene bis aliphatic amides; 4)ester waxes such as fatty acid lower alcohol esters, fatty acid polyhydric alcohol esters, and fatty acid polyglycol esters; 5) alcohol waxes such as fatty alcohols, polyhydric alcohols, and polyglycerol; 6) metal soaps, and 7) mixtures of these.

Those which are used preferably from the viewpoints of effect and cost performance are 1) liquid paraffin and microcrystalline wax among the hydrocarbon waxes, 2) stearic acid and lauric acid among the aliphatic waxes, 3) stearic acid amide, palmitic acid amide, oleic acid amide, erucic acid amide, methylenebisstearyloamide, and ethylenebisstearyloamide among the aliphatic amide waxes, 4) butyl stearate, hardened castor oil, and ethylene glycol monostearate among the ester waxes, 5) cetyl alcohol and stearyl alcohol among the alcohol waxes, and 6) aluminum stearate and calcium stearate among the metal soaps.

The above-mentioned hydrophobic plasticizer includes at least one compound selected from (1) to (8) shown below.

(1) H₅C₃ (OH)₃₋ₙ(OOCCH₃)ₙ 0<n≦3

This indicates mono-, di- or triacetate of glycerin and may be mixtures of these. n closer to 3 is preferable.

(2) Glycerin alkylate (the alkyl moiety has 2 to 20 carbon atoms and may have a radical of a hydroxyl group), or diglycerin alkylate; for example, glycerin tripropionate, glycerin tributyrate, and diglycerin tetraacetate.

(3) Ethylene glycol alkylate (the alkyl moiety has 1 to 20 carbon atoms and may have a radical of a hydroxyl group); for example, ethylene glycol diacetate.

(4) Polyethylene glycol alkylate having 5 or less ethylene recurring units (the alkyl moiety has 1 to 20 carbon atoms and may have a radical of a hydroxyl group); for example, diethylene glycol monoacetate and diethylene glycol diacetate.

(5). Aliphatic monocarboxylic acid alkyl ester (the alkyl moiety has 1 to 20 carbon atoms); butyl stearate.

(6) Aliphatic dicarboxylic acid alkyl ester ((the alkyl moiety has 1 to 20 carbon atoms and may have a radical of a carboxyl group); for example, di(2-ethylhexyl) adipate and di(2-ethylhexyl) azelate.

(7) Aromatic dicarboxylic acid alkyl ester ((the alkyl moiety has 1 to 20 carbon atoms and may have a radical of a carboxyl group); for example, dibutyl phthalate and dioctyl phthalate.

(8) Aliphatic tricarboxylic acid alkylester (the alkyl moiety has 1 to 20 carbon atoms and may have a radical of a carboxyl group); for example, citric acid trimethyl ester.

(9) Low molecular weight aliphatic polyester having a weight average molecular weight of 20,000 or less; for example, condensate from succinic acid and ethylene glycol/propylene glycol (manufactured by Dainippon Ink and Chemicals, Inc. under trade name: POLYSIZER).

(10) Natural oils and fats as well as their derivatives, for example, soybean oil, epoxylated soybean oil, castor oil, paulownia oil, and rapeseed oil.

The olefin resins that can be used are centered on polyethylene and polypropylene and also include a wide variety of derivatives and copolymers thereof. Examples thereof include LDPE (low density polyethylene), LLDPE (linear low density polyethylene), Very low density polyethylene (VLDPE), EVA (ethylene vinyl acetate copolymer), EVOH (ethylene vinyl alcohol copolymer), metallocene resins, PP (polypropylene), IO (ionomer), EAA (ethylene acrylic acid copolymer), EMMA (ethylene methyl methacrylate copolymer), EMA (ethylene methyl acrylate copolymer), EEA (ethylene ethyl acrylate copolymer), adhesive polyolefin resins and so forth. In view of dispersibility with the lactic acid-based resins, resins having a small amount of polar functional groups such as EVA or IO than homopolymers.

Examples of the carbodiimide compound include those compounds which have at least one carbodiimide group. The carbodiimide compounds may be any one of aliphatic, alicyclic, and aromatic carbodiimides.

Specific examples of the carbodiimide include poly(4,4′-diphenylmethanecarbodiimide), poly(p-phenylenecarbodiimide), poly(m-phenylenecarbodiimide), poly(tollylcarbodiimide), poly(diisopropylphenylenecarbodiimide), poly(methyl-diisopropylphenylenecarbodiimide), and poly(triisopropylphenylenecarbodiimide). The carbodiimide compounds are used singly or two or more of them may used in combination.

The amount of hydrolysis inhibitor to be added is 10% by weight or less, preferably 0.1% by weight or more and 3% by weight or less. When the amount of the hydrolysis inhibitor is above 10% by weight, problems occur in that molded parts will have decreased processability and physical properties and so forth.

The amount of the plasticizer to be added is 50% by weight or less, preferably 0.5% by weight or more and 20% by weight or less. Addition of excess amounts of olefin resins will cause a decrease in impact strength or failure of appearance. On the other hand, addition of excess amounts of the hydrophobic waxes, hydrophobic plasticizers, or carbodiimide compounds will cause a decrease in molding processability due to a reduction in viscosity, a decrease in mechanical strength, and bleeding or sticking on the surface of the molding.

When soft parts or elastic parts are to be obtained, a technique of addition of a plasticizer to the lactic acid-based resin composition in addition to the technique of copolymerization of a soft component is effective.

The plasticizers that can be used are not limited; for example the plasticizers are used preferably from examples of the above-mentioned hydrophobic plasticizer. When the amount of the plasticizer is above 50% by weight, the plasticizers will bleed for timewise and it will occur to decrease remarkably physical properties.

To obtain moldings for use in automobile parts, home electric appliances and so forth having higher heat resistance, stereo complexes may be formed. This is achieved by well mixing substantial poly-L-lactic acid and substantial poly-D-lactic acid with each other. Here, “well mixing” in industry means sufficiently kneading by using an extruder with twin screws rotating in the same orientation. In this manner, stereo complexes can be formed. “Substantial poly-L-lactic acid” as used herein means that the lactic acid-based resin has a DL composition such that L-form:D-form=100:0 to 90:10, preferably 100:0 to 94:6 while “substantially poly-D-lactic acid” as used herein means that the lactic acid-based resin has a DL composition such that L-form:D-form=0:100 to 10:90, preferably 0:100 to 6:94. Usually, the above-mentioned lactic acid-based resin has a melting temperature of 140 to 170° C. Converting the resin into a stereocomplex results in an elevation of the melting point to 200 to 230° C. and makes it easy to impart the resin with higher heat resistance.

It is desirable that the moldings of the present invention, for example, automobile parts and home electric appliances are formed by adding antistatic agents to lactic acid-based resins. From the viewpoint of preventing hydrolysis during melt molding, it is preferable that the antistatic agents are selected from the following compounds (1) to (3). The amount of the antistatic agent to be added is 0.1 to 10% by weight, preferably 0.3 to 4.0% by weight.

(1) Polyhydric alcohols such as ethylene glycol, diethylene glycol, triethylene glycol, glycerin, trimethylolpropane, pentaerythritol, and sorbitol and/or aliphatic fatty acid esters thereof;

(2) Polyethylene glycol and/or fatty acid esters thereof;

(3) Polyethylene glycol adducts or polypropylene glycol adducts of higher alcohols, polyhydric alcohols, alkylphenols and so forth.

Further, various additives such as heat stabilizers, antioxidants, UV absorbents, light stabilizers, pigments, coloring agents, lubricants, and nucleating agents may be formulated in amounts within the range in which the effects of the present invention are not deteriorated.

The automobile parts and home electric appliances parts may be molded as a rigid form, an elastic form, a fiber structure form, or an expanded form by appropriately designing the structure, blending composition and molding process of a raw material resin and before it can be utilized.

The rigid forms for automobile parts include a front bumper, a facier, a fender, a side garnish, a pillar garnish, a rear spoiler, a bonnet, a radiator grill, a door handle, a head lump lens, an instrument panel, a trim, an air cleaner case, an air intake duct, a surge tank, a fuel tank, an intake manifold, a distributor part, a fuel injection part, an electric component connector, an engine locker cover, an engine ornament cover, a timing belt cover, a belt tensioner pulley, a chain guide, a cam sprocket, a generator bobbin and so forth.

The elastic forms for automobile parts include a rubber cushion for engine, various tubes, various packings, tires, a timing belt and so forth. The fiber structures for automobile parts include a sheet, a pillow, a matte, an inner plate, a door panel, a door board, a ceiling material, an air bag, a seat belt, interior materials and so forth. The foamed forms for automobile parts include a sheet cushion, a heat insulating sheet, interior materials and so forth.

Rigid forms for home electric appliances include a casing, a cabinet, a roller, a fan, a bearing, a printed circuit board, a connector, a bulb, a case, a shield plate, a button, a switch handle and so forth. Elastic forms for home electric appliances include a rubber cushion, a tube, a packing, a door sash, a timing belt and so forth. Fiber structure forms for home electric appliances include a filter, a cover and so forth. Foamed forms for home electric appliances include a heat insulating material, space filler and so forth.

Now, a molding method will be described. The molding method and apparatus for molding automobile parts, home electric appliances and so forth that can be used in the present invention include known methods and apparatus. More particularly, injection molding, extrusion molding, press molding, blow molding and a sheet molding compound (SMC) method are advantageously used depending on the shape of moldings. Fiber structure forms are processed into forms of woven fabric, nonwoven fabric, knitting, FRP, SMC and so forth.

When melt molding such as injection molding, extrusion molding or blow molding is performed, a dry blend of the respective components of the composition may be directly fed to a molding machine. It is, however, desirable that compounding is performed in advance by using a twin-screw extruder or the like to pelletize the composition. It is more advantageous to perform compounding in advance from the viewpoints of exhibition of the function of each component and total workability.

What is important in the present invention is to control the relative degree of crystallization of the lactic acid-based resin components contained in the lactic acid-based resin composition to 30 to 100%, for example, by adjusting the composition of resin, the temperature of resin, the temperature of the mold, the cooling conditions (in particular, the temperature of the mold), or by performing reheating treatment. If the relative degree of crystallization is below 30%, it tends to be difficult to obtain heat resistance or wet heat durability of the moldings. In particular, from the viewpoint of heat resistance, the moldings will be deformed in an atmosphere above 60° C., so that their use as automobile parts and home electric appliance parts is limited and their application is restricted. Increasing the degree of crystallization prevents the resin from being deformed even when exposed to an atmosphere at 60 to 130° C. Although the relative degree of crystallization may vary depending on the DL ratio of the lactic acid-based resin, kind of composition, addition of a nucleating agent and so forth, generally the slower the cooling rate, the higher the relative degree of crystallization.

In the case of the molding method using a mold, it is preferable that the temperature of the mold is 60 to 130° C., preferably 80 to 120° C. in order to balance the relative degree of crystallization and moldability.

When the temperature of the mold is below 60° C., the crystallization rate is low, so that it takes too long a time to obtain a desired relative degree of crystallization. On the other hand, when the temperature of the mold is above 130° C., sticking of the molding to the mold tends to occur in spite of an increased crystallization rate, so that sometimes the molding cycle number is not increased, the molding is deformed when taken out from the mold, and further contrariwise the crystallization rate is decreased at high temperatures. Time of contact with the mold is adjusted within the range of 1 to 1,000 seconds, preferably 10 to 100 seconds.

Further, depending on the application, it is preferable that the automobile parts, home electric appliance parts and so forth are formed as complexes with natural fibers. The term “natural fibers” as used herein refers to linen, jute, kenaf, bagasse, corn fiber, bamboo fiber, wool and so forth. In a broad sense, natural fibers also include rayon, biscose, acetate and so forth, which are derived from natural substances.

Compounding of the lactic acid-based resins with natural fibers increases the rigidity and impact strength of parts. In recent years, there has been a trend in which glass fiber is avoided in the automobile industry and the home electric appliance industry from the viewpoints of specific density and recyclability. Use of natural fibers causes such inconveniences. In addition, since the lactic acid-based resins are produced from starch as a raw material, all the components are derived from plants so that the integration of the concept is achieved.

While mixing ratio of the natural fiber may vary depending on the application, a mixing ratio of lactic acid-based resin composition:natural fiber=99:1 to 60:40 (% by weight) is preferable. If the mixing ratio of the natural fiber is smaller than the above-mentioned range, no effect of improving rigidity and impact strength is obtained while if the mixing ratio of the natural fiber is greater than the above-mentioned range, the molding processability and mechanical properties are decreased.

The methods of compounding the natural fibers include a method in which short fibers are kneaded into a resin composition and the mixture is subjected to fiber drawing molding to obtain a long fiber-reinforced resin pellets (LFP) and an impregnation method in which the lactic acid-based resin composition is impregnated into woven fabric or nonwoven fabric by press molding, and a press molding method in which a mixed woven fabric of the lactic acid-based resin composition and a natural material is press molded and so forth.

Any known method may be used for expansion molding. Mode of molding may be any of mold expansion and extrusion expansion. Means of expansion include chemical expansion, gas expansion, stretching void expansion and so forth. From the relationship with the melting point of the lactic acid-based resin, preferable examples of chemical expansion agent include azodicarbonamide (ADCA) and sodium hydrogen carbonate. As the gas for use in gas expansion, carbon dioxide facilitates formation of uniform cells. In extrusion expansion, it is recommended to add 0.05 to 2.0% by weight of organic peroxides such as dicumyl peroxide, 1,1-di-t-butylperoxycyclohexane, t-butyl peroxy-3,5,5-trimethylhexanoate,2,2-di-t-butylperoxybutane, t-butylperoxyisopropyl carbonate, t-butylperoxy-2-ethylhexyl carbonate, t-amyl peroxybenzoate, t-butyl peroxyacetate, 4,4-di-t-butylperoxy-n-butyl valerianate, t-butylperoxy benzoate, 2,5-dimethyl-2,5-di-(t-butylperoky)hexane, 1,3-bis(t-butylperoxyisopropyl)benzene, t-butyl cumyl peroxide, di-t-butyl peroxide, 2,5-dimethyl-2,5-di(t-butylperoxy)hexyne-3 and so forth in order to obtain high tensile strength of the melt.

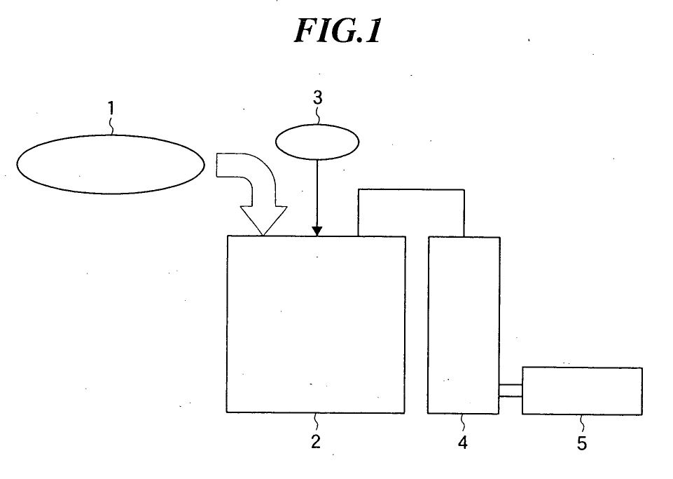

The automobile parts and hole electric appliance parts made from the lactic acid-based resin composition molded as described above can easily undergo recycling of wastes (recycling to produce a resource) after their use through the stage of shredder dust for recycling to produce a resource. That is, as a basic procedure, it only needed to fill shredder dust that could contain metals and/or glass as contaminants in a sealed vessel and heat it with purging by an inert gas such as dehumidified air or nitrogen to decompose the lactic acid-based resin and recover the formed vapor formed. FIG. 1 is a schematic diagram illustrating a method for recovering lactide according to an embodiment of the present invention. To explain the present invention referring to FIG. 1, shredder dust 1 for recycling to produce a resource is charged in a heating vessel 2, which is heated by a heating means (not shown) while purging by an inert gas 3 to generate a vapor component. The generated vapor component is cooled in a cooling vessel (vessel for recovering lactide) 4 to become solid lactide, which are then recovered. Note that the cooling is preferably performed under the conditions where a reduced pressure is established by removing inert gas and the like by a pressure reduction unit 5.

The heating temperature is desirably within the range of 150 to 280° C., preferably 170 to 250° C. If the heating temperature is below 150° C., vapor is generated in small ratios, resulting in an increased cost for industrial application. On the contrary, use of the heating temperature above 280° C. results in an increased contribution of a side reaction, thus making it difficult to recover effective vapor. Setting the heating vessel and recovery passages under a reduced pressure of 100 torr or less, preferably 20 torr or less facilitates recovering vapor.

The main component of vapor is lactide which is a monomer of polylactic acid and includes a small amount of lactic acid and a dimer of lactic acid. Since L-lactide and D-lactide have a melting temperature of 95° C., cooling of the recovery system at 95° C. or less, preferably 60° C. or less, more preferably 30° C. or less increases the recovery efficiency of solid lactide.

In the recovery method of the present invention, even if one or more of metals, glass, other resins exist as contaminants in the shredder dust for recycling to produce a resource, substantially only heating can provide highly pure lactide. Therefore, as compared with conventional chemical recycling methods, the recovery method of the present invention is remarkably excellent. Furthermore, the recovery method of the present invention can recover lactide by substantially two steps, i.e., a heating step and a cooling step, so that a smaller number of steps or reduction in number of steps can be achieved.

Recovering lactide by using the shredder dust for recycling to produce a resource according to the present invention also provides an advantage that a larger surface area of shredder dust improves the efficiency of recovery.

Addition of 0.1 to 3% by weight of tin compounds such as tin lactate, tin tartrate, tin dicaprylate, tin dilaurate, tin dipalmitate, tin distearate, tin dioleate, tin α-naphthoate, tin β-naphthoate, and tin octylate, titanium compounds such as tetrapropyl titanate, zirconium compounds such as zirconium isopropoxide to the shredder dust upon heating accelerates decomposition rate of the lactic acid-based resin. However, this is not always necessary. It is considered that shredder dust contains more or less catalyst component such as metals and exhibit a similar effect of acceleration. That is, use of the shredder dust for recycling to produce a resource according to the present invention can give rise to lactide having a high purity without addition of catalysts.

In addition, when the constituent consisting of the lactic acid-based resin composition in the shredder dust contain 0.1 to 11.0% by weight of moisture, the effect of accelerating decomposition rate can be obtained. If the moisture percentage is 0.1% by weight or less, there will be no difference in decomposition rate from the case where no moisture is contained. On the contrary, if the moisture percentage is above 1.0% by weight, decomposition is fast but the yield of the lactide which is an active ingredient is disadvantageously decreased. It is believed that the main chain of the lactic acid-based resin is cleaved in the presence of moisture to increase the number of terminals that serve as active sites for lactide generation.

The thus recovered lactide can be polymerized again by a known method as described in U.S. Pat. No. 4,057,537 and readily used as a lactic acid-based resin.

According to the present invention, once automobile parts are discharged, they are converted into shredder dust for recycling to produce a resource and then lactide is recovered from the shredder dust in a small number of steps. From the shredder dust is formed lactic acid, from which in turn is used to produce again moldings for automobile parts, home electric appliances. That is, conversion of from lactic acid to automobile parts and so forth and then from the shredder dust thereof to lactic acid can be repeated in any desired number of times, thus achieving recycling in a true sense of the word. Note that the automobile parts and the like are the same as those as the object of the shredder dust for recycling to produce a resource so that they can be produced in the same manner by using the above-mentioned lactic acid-based resin composition.

### EXAMPLES

Hereinafter, the present invention will be described in detail by way of examples and comparative examples. However, the present invention should not be construed as being limited by the examples and comparative examples.

Note that measured values and evaluations were obtained by performing measurements and evaluations under the following conditions and optionally by calculation.

(1) Relative Degree of Crystallization

Molding was chipped into scales of about 5 mm φ and about 10 mg and temperature elevation was measured according to JIS-K7121 by using a DSC-7 differential scanning calorimeter manufactured by Perkin-Elmer. Calculation was performed according to the following equation:

Relative degree of crystallization (% by weight)={(ΔHm−ΔHc)/ΔHm}×100

Here, ΔHm: Heat of melting of lactic acid-based resin component
ΔHc: Heat of crystallization of lactic acid-based resin component.
   (2) Izod Impact Strength

A sample directly molded into a size of 10 mm in width×80 mm in length×4 mm in thickness or cut out from a molding was subjected to notched (notch type A) edgewise Izod impact test according to JIS-0180 by using a universal impact strength test machine (Model No. 258) manufactured by Yasuda Seiki Seisakusho Co., Ltd. Note that unit was KJ/m².

(3) Heat Resistance

Moldings were left stand in a hot blast oven at 100° C. for 30 minutes. Judgment was performed visually. The moldings that showed no deformation was assigned ◯, the moldings that showed a slight deformation was assigned Δ, and the moldings that showed a clear deformation was assigned X. In addition, for some moldings, tests were performed at 130° C. The moldings that showed no deformation in tests at 130° C. were assigned ⊚.

(4) Weight Average Molecular Weight of Lactic Acid-Based Resin

GPC-800 CP of Shim-Pack series, columns for chromatography manufactured by Shimadzu Corporation was attached to gel permeation chromatography apparatus HLC-8120 GPC manufactured by Tosoh Corporation and measurements were performed using chloroform under the conditions of a solvent in a concentration of solution of 0.2% (wt/vol), an injection amount of solution of 200 μl, a solvent flow rate of 1.0 ml/minute, and a solvent temperature of 40° C. Weight average molecular weight (Mw) of the lactic acid-based resin was calculated in terms of polystyrene. The weight average molecular weights of standard polystyrenes used were 2,000,000, 670,000, 110,000, 35,000, 10,000, 4,000, and 600, respectively.

(5) Wet Heat Resistance (Molecular Weight Retention Ratio)

Moldings were left to stand in an incubator at constant temperature and constant humidity LH-112 manufactured by Tabai Espec Co., Ltd. adjusted to 85° C.×85% by weight for 30 hours. The molecular weight retention rate (% by weight) of the lactic acid-based resin before and after the test was calculated according to the following equation:

Molecular weight retention rate (% by weight)=[{(weight average molecular weight of lactic acid-based resin before test)−(weight average molecular weight of lactic acid-based resin after test)}/(weight average molecular weight of lactic acid-based resin before test)]×100

◯ Molecular weight retention rate of 75 to 100 wt %

Δ Molecular weight retention rate of 50 to 74 wt %

X Molecular weight retention rate of 0 to 49 wt %.

(6) Moisture Percentage

Constituents consisting of lactic acid-based resin composition were separated from among the shredder dust visually and moisture percentages were obtained by a Karl-Fisher method.

(7) Flexural Elastic Modulus of a Board and Maximum Bending Load

A test piece of 50×150 mm was supported by two points located at a distance of 100 mm and a load was applied to the sample from above at a rate of 50 mm/minute at middle point between the two supporting points. From the relationship between the displacement and load, flexural elastic modulus and maximum bending load was calculated.

(8) Recyclability

Recyclability was calculated in percentage (%) by dividing the weight of the lactic acid-based resin obtained by recycling by the weight of the lactic acid-based resin initially required for molding a part and judgment was performed according to the following criteria.

◯: Recycling rate of between 50 to 100% by weight

Δ: Recycling rate of between 20 to 49% by weight

X: Recycling rate of between 0 to 19% by weight.

(9) Over-All Evaluation

Comprehensively judging the above-mentioned evaluation results, evaluation was performed according to the following standards.

⊚ Particularly excellent

◯ Good

Δ Usable depending on restricted application and the like

X Failure.

### Example 1

Lactic acid-based resin Nature Works 4031D (weight average molecular weight of 200,000) manufactured by Cargill Dow, which has a compositional ratio of L-form:D-form=99:1, aliphatic polyester resin (polybutylene succinate adipate): Bionore 3003 having a glass transition temperature of −45° C. manufactured by Showa High Polymer Co., Ltd., talc: Micro Ace L manufactured by Nippon Talc Co., Ltd. as an inorganic filler, and carbodiimide: Stabaczol P manufactured by Bayer as a hydrolysis inhibitor were dry blended in ratios of a lactic acid-based resin/aliphatic polyester/inorganic filler/hydrolysis inhibitor=65/28/15/2 (parts by weight) and compounded at 200° C. by using a small extruder with twin screws rotating in the same orientation manufactured by Mitsubishi Heavy Industry Co., Ltd to obtain raw material pellets.

The compounded raw material was injection molded into a casing of a cellular phone (2 pieces, weighting 22 g) having a size of 35×118×17 mm by using an injection molding machine TS170 manufactured by Toshiba Corporation at a resin temperature of 200° C. and a mold temperature of 40° C. Then, the casing was fixed to a frame and heated at 80° C. for 10 minutes to perform crystallization treatment.

To this casing were attached a metal frame weighing 0.5 g and an acrylic resin window weighing 1.2 g. Then, the casing was coated with two-pot urethane coating composition to provide a metallic blue coating thereon. In this casing were assembled conventional parts as other parts such as a mounting unit, a shield plate, a polydome, antenna housing case and so forth. It was confirmed that the thus assembled cellular phone could be used without problems from the view point of telephone function. Table 1 shows results of measurements of relative degree of crystallization and results of evaluation of heat resistance and wet heat durability in combination.

Simultaneously, the resin was fed to a small injection molding machine PS40E5A manufactured by Nissei Plastic Industrial Co., Ltd. provided with a mold in the form of Izod test specimen and injection molded at a cylinder temperature of 200° C. and a mold temperature of 80° C. at a molding cycle of 40 seconds to obtain moldings. Table 1 shows results of tests on the impact strength of the moldings.

Then, hundred cellular phones after use were disassembled and the mounting unit, shield plate, polydome, antenna housing case and so forth were removed and the remaining housing part (with the window and window frame) was pulverized by using a plastic pulverizer, Planky PC22, manufactured by Watanabe Steelworks Co., Ltd. to make shredder dust in which metals and acrylic resin were mixed as contaminants.

The shredder dust (moisture percentage 0.3%) was placed in a 10-liter stainless steel container connected to a cooling apparatus and heated at 230° C. while purging by a small amount of nitrogen with reducing pressure at 10 torr on the side of the cooling apparatus and left to stand for 3 hours.

As a result, 1.8 kg of needle-like crystals was deposited on the cooling wall surface. IR measurement revealed that the crystal was L-lactide. Calculation from the amount of lactic acid-based resin upon molding indicated that the recovery rate was 80% or more. In the heating container remain residues of the acrylic resin of the acrylic resin window, the metal of window frame, the urethane coating composition, the inorganic filler, undecomposed lactic acid-based resin.

To the recovered L-lactide was added 15 ppm of tin octylate and the mixture was placed in a 5-liter batch type polymerization tank equipped with a stirrer and a heating device. While purging with nitrogen, polymerization was performed at 185° C. and a stirring rate of 100 rpm for 120 minutes. The obtained melt was fed to an extruder with twin-screws of 30-mm φ rotating in the same orientation provided with three vacuum vents manufactured by Mitsubishi Heavy Industry, Ltd. and the melt was extruded in strands at 200° C. at a vent pressure of 4 torr while removing vapors, thus obtaining pellets. The obtained lactic acid-based resin had a weight average molecular weight of 200,000 and an L-form content of 99.5%. Thus, 1.6 kg of lactic acid-based resin could be obtained and the recycling rate of lactic acid-based resin was 72%.

### Example 2

A casing of cellular phone was molded and then assembled in a cellular phone in the same manner as in Example 1 except that Easterbio, an aliphatic-aromatic polyester resin, manufactured by Eastman Chemical was used in place of the aliphatic polyester resin in Example 1. Thereafter, shredder dust was prepared, then L-lactide was recovered, and pellets of the lactic acid-based resin were prepared in the same manner as in Example 1. Further, evaluation was performed in the same manner as in Example 1. Table 1 shows the results. Note that the lactic acid-based resin composition contained in the shredder dust had a moisture percentage of 0.3%.

### Example 3

A casing of cellular phone was molded and then assembled in a cellular phone in the same manner as in Example 1 except that no hydrolysis inhibitor was added and the ratios of the components were changed such that lactic acid-based resin/aliphatic polyester/inorganic filler/hydrolysis inhibitor=65/30/15/0 (parts by weight). Thereafter, shredder dust was prepared, then L-lactide was recovered, and pellets of the lactic acid-based resin were prepared in the same manner as in Example 1. Further, evaluation was performed in the same manner as in Example 1. Table 1 shows the results. Note that the lactic acid-based resin composition contained in the shredder dust had a moisture percentage of 0.3%.

### Example 4

A casing of cellular phone was molded and then assembled in a cellular phone in the same manner as in Example 1 except that a portion of the inorganic filler (3 parts by weight out of 15 parts by weight) was replaced by organic converted bentonite, lammelar silicate, manufactured by Hojun Co., Ltd. Thereafter, shredder dust was prepared, then L-lactide was recovered, and pellets of the lactic acid-based resin were prepared in the same manner as in Example 1. Further, evaluation was performed in the same manner as in Example 1. Table 1 shows the results.

However, the organic converted bentonite used was an inorganic filler for nano-composite, surface treated with trimethylstearylbenzylammonium on the surface thereof. Electron microscopic observation confirmed that the obtained molding formed nano-composite.

At the same time, tests at 130° C. at which deformation would occur in the molding obtained in Example 1 were also performed as heat resistance tests, which indicated no deformation. Note that the lactic acid-based resin composition contained in the shredder dust had a moisture percentage of 0.2%.

### Example 5

A casing of cellular phone was molded and then assembled in a cellular phone in the same manner as in Example 1 except that the ratios of the components were changed such that lactic acid-based resin/aliphatic polyester/inorganic filler/hydrolysis inhibitor=83/0/15/2 (parts by weight). Thereafter, shredder dust was prepared, then L-lactide was recovered, and pellets of the lactic acid-based resin were prepared in the same manner as in Example 1. Further, evaluation was performed in the same manner as in Example 1. Table 1 shows the results. The obtained molding had poor impact strength and thus was not desirable. However, it was still usable for limited applications and in limited methods of using it. Note that the lactic acid-based resin composition contained in the shredder dust had a moisture percentage of 0.3%.

### Example 6

A casing of cellular phone was molded and then assembled in a cellular phone in the same manner as in Example 1 except that no crystallization treatment after injection molding was performed. Thereafter, shredder dust was prepared, then L-lactide was recovered, and pellets of the lactic acid-based resin were prepared in the same manner as in Example 1. Further, evaluation was performed in the same manner as in Example 1. Table 1 shows the results. The obtained molding had poor heat resistance and thus was not desirable. However, it was still usable for limited applications and in limited methods of using it. Note that the lactic acid-based resin composition contained in the shredder dust had a moisture percentage of 0.4%.

### Example 7

A casing of cellular phone was molded and then assembled in a cellular phone in the same manner as in Example 1 except that a half portion of the lactic acid-based resin was replaced by poly-D-lactic acid:Purasorb Polymer PD manufactured by Purac Ltd. Thereafter, shredder dust was prepared, then lactide was recovered, and pellets of the lactic acid-based resin were prepared in the same manner as in Example 1. Further, evaluation was performed in the same manner as in Example 1. Table 1 shows the results. On this occasion, a partial formation of stereocomplex by blending poly-L-lactic acid and poly-D-lactic acid and stirring the mixture sufficiently was confirmed by DSC.

Further, tests at 130° C. at which deformation would occur in the molding obtained in Example 1 were also performed as heat resistance tests, which indicated no deformation. Note that the lactic acid-based resin composition contained in the shredder dust had a moisture percentage of 0.3%.

### Example 8

A casing of cellular phone was molded and then assembled in a cellular phone in the same manner as in Example 1 except that 10 parts by weight of bamboo fiber (diameter: 70 μm, fiber length: 500 μm) manufactured by Hirosue Sangyo Co., Ltd. to the resin composition in Example 1 and compound pellets of a composition such that lactic acid-based resin/aliphatic polyester/inorganic filler/hydrolysis inhibitor/bamboo fiber=65/28/15/2/10 (parts by weight) were used. Thereafter, shredder dust was prepared, then L-lactide was recovered, and pellets of the lactic acid-based resin were prepared in the same manner as in Example 1. Further, evaluation was performed in the same manner as in Example 1. Table 1 shows the results.

Further, tests at 130° C. at which deformation would occur in the molding obtained in Example 1 were also performed as heat resistance tests, which indicated no deformation. Note that the lactic acid-based resin composition contained in the shredder dust had a moisture percentage of 0.5%.

TABLE 1

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Relative | 90 | 83 | 90 | 90 | 81 | 15 | 89 | 90 |
| degree of | | | | | | | | |
| crystallization | | | | | | | | |
| (wt %) | | | | | | | | |
| Heat | ◯ | ◯ | ◯ | ⊚ | ◯ | X | ⊚ | ⊚ |
| resistance | | | | | | | | |
| Wet heat | ◯ | ◯ | Δ | ◯ | ◯ | ◯ | ◯ | ◯ |
| resistance | | | | | | | | |
| Izot Impact | 30 | 32 | 32 | 30 | 2 | 31 | 29 | 34 |
| strength | | | | | | | | |
| (KJ/m²) | | | | | | | | |
| Recyclability | ◯ | ◯ | ◯ | ◯ | ◯ | ◯ | ◯ | ◯ |
| Over-all | ◯ | ◯ | Δ | ⊚ | Δ | Δ | ⊚ | ⊚ |
| evaluation | | | | | | | | |

### Example 9

A casing of cellular phone was molded and then assembled in a cellular phone in the same manner as in Example 1 except the moisture percentage of the lactic acid-based resin composition contained in the shredder dust to be placed in the stainless steel container for recovery by heating was adjusted to 8%. Thereafter, shredder dust was prepared, then L-lactide was recovered, and pellets of the lactic acid-based resin were prepared in the same manner as in Example 1. Further, evaluation was performed in the same manner as in Example 1. Table 2 shows the results.

### Example 10

A casing of cellular phone was molded and then assembled in a cellular phone in the same manner as in Example 1 except the stainless steel container for recovery by heating was heated at 300° C. Thereafter, shredder dust was prepared, then L-lactide was recovered, and pellets of the lactic acid-based resin were prepared in the same manner as in Example 1. Further, evaluation was performed in the same manner as in Example 1. Table 2 shows the results. Note that the lactic acid-based resin composition contained in the shredder dust had a moisture percentage of 0.3%.

TABLE 2

| | Example 9 | Example 10 |
|---|---|---|
| Recyclability | Δ | Δ |

### Example 11

Jute fiber (average fiber diameter: 20 denier, fiber length: 30 to 50 mm) and lactic acid-based resin fiber (Lactron manufactured by Kanebo Gosen, Ltd.; 100% poly-L-lactic acid having a weight average molecular weight of 150,000, fiber diameter:5 denier, fiber length 50 mm) were uniformly mixed such that jute fiber:lactic acid-based resin fiber=70/30 by weight ratio to fabricate a web with a basis weight of 150 g/m². This web was needle punched at a density of 200 needles/m² to fabricate a needle punched nonwoven fabric of 3 mm in thickness. The nonwoven fabric was pinched between hot rolls at a roll temperature of 180° C. with an inter-roll clearance of 0.25 mm to obtain a sheet of 0.3 mm in thickness.

The sheet was cut into 1 mm square pieces. 10 such pieces were superposed one on another and the laminate was hot-pressed at 180° C. for 15 minutes by using a 100-ton hot press and then slowly cooled in 15 minutes to cause crystallization, thus obtaining a board.

The obtained board had a flexural elastic modulus of 3.6 GPa and a maximum bending load of 28 N/50 mm, which were superior to a board fabricated by using conventional PP fiber and kenaf fiber.

The thus obtained board was used as a rear door board and was attached to the rear door of Dingo manufactured by Mitsubishi Motors, a family automobile, and the automobile was run for a total of 2,000 km in 2 months, with causing no problem. The door portion was pulverized by using a bulky garbage pulverizer manufactured by Mitsubishi Heavy Industries, Ltd. to an average diameter of about 6 mm. The pulverisate was classified by using magnetic type separator, a wind power separator, and a sieve to separate iron contents to thereby obtain shredder dust. The shredder dust is placed in a 50-liter stainless steel container and examination of recyclability was performed in the same manner as in Example 1. In this case, however, the moisture percentage of the shredder dust was 0.4%. The recycling rate after the steps of recovery of lactide and polymerization of lactic acid-based resin was 75% based on the weight of the lactic acid-based resin fiber used, which was preferable.

As described in detail above, the present invention can provide automobile parts, home electric appliance parts, moldings, having excellent physical properties and recyclability, and shredder dust for recycling to produce a resource as well as a method for recycling the shredder dust having excellent cost performance.

The present invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

1-4. (canceled)

5. Shredder dust for recycling to produce a resource, derived from a molding from a lactic acid-based resin composition, wherein the lactic acid-based resin composition comprises:
1) 30 to 100% by weight of a lactic acid-based resin;
2) 0 to 50% by weight of at least one member selected from the group consisting of an aliphatic polyester and an aromatic-aliphatic polyester having a glass transition temperature, Tg, of 0° C. or less;
3) 0 to 50% by weight of an inorganic filler;
4) 0 to 10% by weight of a hydrolysis inhibitor; and
5) 0 to 50% by weight of a plasticizer.

6. The shredder dust for recycling to produce a resource according to claim 5,
wherein the lactic acid-based resin composition contains 0.1 to 50% by weight of the inorganic filler; and
wherein at least a portion of the inorganic filler is lamellar silicate; and
wherein the lamellar silicate forms nano-composite after molding.

7. The shredder dust for recycling to produce a resource according to claim 5, wherein the molding is an automobile part or a home electric appliance part.

8. The shredder dust for recycling to produce a resource according to claim 5, wherein the lactic acid-based resin has a relative degree of crystallization of 30 to 100%.

9. The shredder dust for recycling to produce a resource according to claim 5, wherein the hydrolysis inhibitor is at least one member selected from the group consisting of hydrophobic waxes, hydrophobic plasticizers, olefin resins and carbodiimides.

10-24. (canceled)
